(19) United States
(12) Patent Application Publication
(10) Pub. No.: US 2026/0361435 A1
(43) Pub. Date: Nov. 12, 2026

(54) RADIO WAVE VISUALIZATION SYSTEM, EVALUATION CONDITION CREATION DEVICE, RADIO WAVE VISUALIZATION METHOD AND EVALUATION CONDITION CREATION PROGRAM

(71) Applicant: NTT, Inc., Tokyo (JP)

(72) Inventors: Tomoki MURAKAMI, Musashino-shi, Tokyo (JP); Tomoaki OGAWA, Musashino-shi, Tokyo (JP); Masashi IWABUCHI, Musashino-shi, Tokyo (JP); Riku OMIYA, Musashino-shi, Tokyo (JP); Ryotaro TANIGUCHI, Musashino-shi, Tokyo (JP)

(73) Assignee: NTT, Inc., Tokyo (JP)

(21) Appl. No.: 19/126,266

(22) PCT Filed: Nov. 2, 2022
(86) PCT No.: PCT/JP2022/041067

§ 371 Date: May 1, 2025

(51) Int. Cl. H04B 17/391

(52) U.S. Cl. CPC H04B 17/391

(57) ABSTRACT

A radio wave visualization system according to an embodiment includes: UI circuitry configured to output base station information indicating a position of a base station and terminal station information indicating a position and moving state of a terminal station; first evaluation condition creation circuitry configured to create a plurality of evaluation conditions used for evaluating a propagation characteristic of radio waves for a target area; and second evaluation condition creation circuitry configured to create a plurality of evaluation conditions used for evaluating the propagation characteristic of radio waves for the target area, the performance of the wireless communication system, and an environment of the target area according to an assumed frequency of use of radio waves in order from a highly frequent area where the frequency of use of radio waves is assumed to be high.

### TECHNICAL FIELD

The present invention relates to a radio wave visualization system, an evaluation condition creation device, a radio wave visualization method, and an evaluation condition creation program.

### BACKGROUND ART

In recent years, introduction of new wireless communication systems represented by 5th generation mobile communication system (5G) and local 5G has been explosively increased. In a case where those wireless communication systems are installed, evaluation utilizing radio wave propagation simulation is essential. In order to efficiently evaluate radio wave propagation, there has been studied a technique of visualizing a result of radio wave propagation simulation to optimize settings of the wireless communication system.

For example, in a case where radio wave propagation is visualized, a propagation simulation is performed by creating a three-dimensional environment model for an environment in which the wireless communication system is installed and setting basic performances of the wireless communication system (center frequency, frequency band, transmission power, antenna condition, and installation position) and evaluation conditions necessary for the propagation simulation (e.g. number of reflections, number of diffractions, and transmission/reflection conditions) (see, for example, Non Patent Literature 1).

The radio wave propagation simulation and visualization are desirably performed before the wireless communication system is installed. In a case where the wireless communication system is installed in an actual environment, a requirement condition may be different depending on a change in environment or for each communication area. Therefore, a system that can evaluate radio wave propagation characteristics in real time is required.

### CITATION LIST

### Non Patent Literature

Non Patent Literature 1: Tetsuro Imai, “Mobile Radio Propagation Simulation Based on Ray-Tracing Method”, The Institute of Electronics, Information and Communication Engineers, 2009, IEICE Transactions B Vol. J 92-B No. 9, pp.1333-1347

### SUMMARY OF INVENTION

### Technical Problem

However, in order to visualize radio wave propagation in real time, real-time operation of each step for performing a propagation simulation is essential. In particular, it is known that calculation in the propagation simulation is a bottleneck. Specifically, when an evaluation condition for the propagation simulation becomes complicated, a calculation load increases exponentially. This makes it difficult to perform visualization in real time.

The present invention has been made in view of the above problems, and an object thereof is to provide a radio wave visualization system, an evaluation condition creation device, a radio wave visualization method, and an evaluation condition creation program capable of reducing a time required for visualizing radio wave propagation according to an assumed frequency of use of radio waves.

### Solution to Problem

A radio wave visualization system according to an embodiment of the present invention includes: a model creation unit that creates a three-dimensional scale model of an environment including a terrain and a building of an area to be evaluated for a propagation characteristic of radio waves used for a wireless communication system in which a base station and a terminal station perform wireless communication; a UI unit that outputs base station information indicating a position of the base station and terminal station information indicating a position and moving state of the terminal station in response to an operation input by an operator; a first evaluation condition creation unit that creates a plurality of evaluation conditions used for evaluating the propagation characteristic of radio waves for the area on the basis of the base station information and the terminal station information output by the UI unit and performance of the wireless communication system; a second evaluation condition creation unit that creates a plurality of evaluation conditions used for evaluating the propagation characteristic of radio waves for the area on the basis of the base station information and the terminal station information output by the UI unit, the performance of the wireless communication system, and the environment of the area according to an assumed frequency of use of radio waves in order from a highly frequent area where the frequency of use of radio waves is assumed to be high; a propagation simulator that simulates a plurality of propagation characteristics by using the plurality of evaluation conditions created by the first evaluation condition creation unit and the second evaluation condition creation unit for the three-dimensional scale model created by the model creation unit and outputs simulation results; a selection unit that selects the simulation results executed by the propagation simulator by using the evaluation conditions created by the second evaluation condition creation unit in preference to the simulation results executed by the propagation simulator by using the evaluation conditions created by the first evaluation condition creation unit; and a visualization unit that sequentially visualizes the simulation results of the plurality of propagation characteristics selected by the selection unit.

An evaluation condition creation device according to an embodiment of the present invention is an evaluation condition creation device that, for a propagation simulator that simulates a propagation characteristic of radio waves used for a wireless communication system in which a base station and a terminal station perform wireless communication by using a three-dimensional scale model of an environment including a terrain and a building of an area to be evaluated, creates a plurality of evaluation conditions used for evaluating the propagation characteristic of radio waves, the evaluation condition creation device including: a UI unit that outputs base station information indicating a position of the base station and terminal station information indicating a position and moving state of the terminal station in response to an operation input by an operator; a first evaluation condition creation unit that creates a plurality of evaluation conditions used for evaluating the propagation characteristic of radio waves for the area on the basis of the base station information and the terminal station information output by the UI unit and performance of the wireless communication system; and a second evaluation condition creation unit that creates a plurality of evaluation conditions used for evaluating the propagation characteristic of radio waves for the area on the basis of the base station information and the terminal station information output by the UI unit, the performance of the wireless communication system, and the environment of the area according to an assumed frequency of use of radio waves in order from a highly frequent area where the frequency of use of radio waves is assumed to be high.

A radio wave visualization method according to an embodiment of the present invention includes: a model creation step of creating a three-dimensional scale model of an environment including a terrain and a building of an area to be evaluated for a propagation characteristic of radio waves used for a wireless communication system in which a base station and a terminal station perform wireless communication; an operation step of outputting base station information indicating a position of the base station and terminal station information indicating a position and moving state of the terminal station in response to an operation input by an operator; a first evaluation condition creation step of creating a plurality of evaluation conditions used for evaluating the propagation characteristic of radio waves for the area on the basis of the base station information and the terminal station information output in the operation step and performance of the wireless communication system; a second evaluation condition creation step of creating a plurality of evaluation conditions used for evaluating the propagation characteristic of radio waves for the area on the basis of the base station information and the terminal station information output in the operation step, the performance of the wireless communication system, and the environment of the area according to an assumed frequency of use of radio waves in order from a highly frequent area where the frequency of use of radio waves is assumed to be high; a propagation simulation step of simulating a plurality of propagation characteristics by using the plurality of evaluation conditions created in the first evaluation condition creation step and the second evaluation condition creation step for the three-dimensional scale model created in the model creation step and outputting simulation results; a selection step of selecting the simulation results executed in the propagation simulation step by using the evaluation conditions created in the second evaluation condition creation step in preference to the simulation results executed by using the evaluation conditions created in the first evaluation condition creation step; and a visualization step of sequentially visualizing the simulation results of the plurality of propagation characteristics selected in the selection step.

### Advantageous Effects of Invention

According to the present invention, it is possible to reduce a time required for visualizing radio wave propagation according to an assumed frequency of use of radio waves.

### BRIEF DESCRIPTION OF DRAWINGS

FIG. 1 schematically shows an overview of a configuration of a radio wave visualization system according to an embodiment.

FIG. 2 shows an example of a radio wave visualization method of visualizing radio waves by the radio wave visualization system.

FIG. 3 shows a hardware configuration example of an evaluation condition creation device.

### DESCRIPTION OF EMBODIMENTS

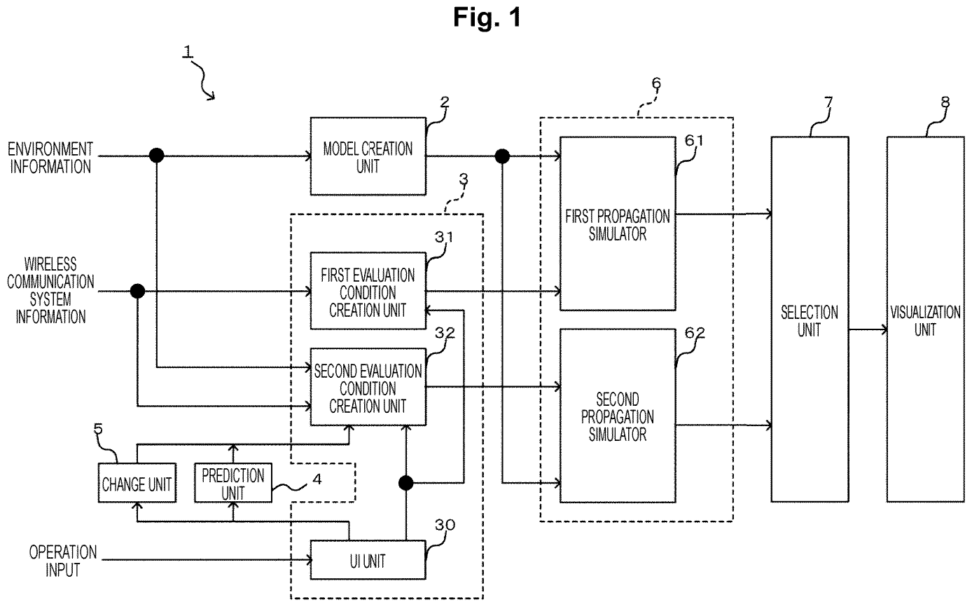

Hereinafter, a radio wave visualization system according to an embodiment will be described with reference to the drawings. FIG. 1 schematically shows an overview of a configuration of a radio wave visualization system 1 according to an embodiment.

As shown in FIG. 1, the radio wave visualization system 1 includes, for example, a model creation unit 2, an evaluation condition creation device 3, a prediction unit 4, a change unit 5, a propagation simulator 6, a selection unit 7, and a visualization unit 8. The radio wave visualization system 1 simulates and visualizes radio wave propagation in an environment including a terrain and a building of an area (target area) where, for example, a wireless communication system in which one or more base stations and one or more terminal stations perform wireless communication is scheduled to be installed.

The model creation unit 2 acquires environment information indicating the environment of the target area and creates a scale model for reproducing the environment of the target area. For example, the model creation unit 2 creates a reduced three-dimensional scale model by using, for example, a three-dimensional (3D) printer from a predetermined material, the three-dimensional scale model reproducing an environment including a terrain and a building of an area to be evaluated for a propagation characteristic of radio waves used for the wireless communication system in which the base station and the terminal station perform wireless communication.

The evaluation condition creation device 3 includes, for example, a user interface (UI) unit 30, a first evaluation condition creation unit 31, and a second evaluation condition creation unit 32.

The UI unit 30 includes, for example, a touchscreen or a mouse and outputs base station information indicating a position of the base station, terminal station information indicating a position and moving state of the terminal station, and the like to the first evaluation condition creation unit 31, the second evaluation condition creation unit 32, the prediction unit 4, and the change unit 5 in response to an operation input by an operator.

For example, the UI unit 30 also includes, in the terminal station information, information indicating acceleration and a moving direction in the operation input using the touchscreen, the mouse, or the like and outputs the information to the prediction unit 4 or the like.

The UI unit 30 also outputs information for distinguishing characteristics of the target area, the terminal station, and the base station in response to an operation input by the operator. For example, the UI unit 30 may be configured to output information for specifying whether the target area is an office, a house, a factory, or the like and information for specifying whether the terminal station is a walking person, a running car, a flying drone, or the like.

The first evaluation condition creation unit 31 acquires wireless communication system information regarding the wireless communication system and creates an evaluation condition used for evaluating a propagation characteristic of radio waves. For example, the first evaluation condition creation unit 31 creates a plurality of evaluation conditions used for evaluating the propagation characteristic of radio waves for the target area on the basis of the base station information and the terminal station information output by the UI unit 30 and performance of the wireless communication system and outputs the evaluation conditions to the propagation simulator 6.

The second evaluation condition creation unit 32 acquires wireless communication system information regarding the wireless communication system and creates an evaluation condition used for evaluating the propagation characteristic of radio waves. For example, the second evaluation condition creation unit 32 creates a plurality of evaluation conditions used for evaluating the propagation characteristic of radio waves for the target area on the basis of the base station information and the terminal station information output by the UI unit 30, the performance of the wireless communication system, and the environment of the target area and outputs the evaluation conditions to the propagation simulator 6 according to an assumed frequency of use of radio waves in order from a highly frequent area where the frequency of use of radio waves is assumed to be high.

The prediction unit 4 predicts a possible movement destination of the terminal station on the basis of, for example, the terminal station information output by the UI unit 30 and outputs a prediction result to the second evaluation condition creation unit 32. In a case where the prediction unit 4 performs prediction, the second evaluation condition creation unit 32 creates a plurality of evaluation conditions used for evaluating the propagation characteristic of radio waves for the target area on the basis of the possible movement destination of the terminal station predicted by the prediction unit 4.

The change unit 5 changes a condition for setting the highly frequent area where the frequency of use of radio waves is assumed to be high for the second evaluation condition creation unit 32 on the basis of, for example, the terminal station information output by the UI unit 30.

The propagation simulator 6 includes, for example, a first propagation simulator 61 and a second propagation simulator 62 and simulates the propagation characteristic of radio waves. Note that the propagation simulator 6 may be configured as one simulator.

The propagation simulator 6 simulates a plurality of propagation characteristics for the three-dimensional scale model created by the model creation unit 2 by using the plurality of evaluation conditions created by the first evaluation condition creation unit 31 and the second evaluation condition creation unit 32 and outputs simulation results to the selection unit 7.

For example, in the propagation simulator 6, the first propagation simulator 61 simulates a plurality of propagation characteristics using the evaluation conditions created by the first evaluation condition creation unit 31, and the second propagation simulator 62 simulates a plurality of propagation characteristics using the evaluation conditions created by the second evaluation condition creation unit 32. That is, the propagation simulator 6 may simulate the plurality of propagation characteristics in parallel. The propagation simulator 6 may also simulate the propagation characteristics in descending order of distance between the base station and the terminal station.

The selection unit 7 selects simulation results executed by the propagation simulator 6 by using the evaluation conditions created by the second evaluation condition creation unit 32 in preference to simulation results executed by the propagation simulator 6 by using the evaluation conditions created by the first evaluation condition creation unit 31. Then, the selection unit 7 outputs the simulation results to the visualization unit 8 in the selected order.

The visualization unit 8 is, for example, a display (display device) and sequentially visualizes the simulation results of the plurality of propagation characteristics selected by the selection unit 7.

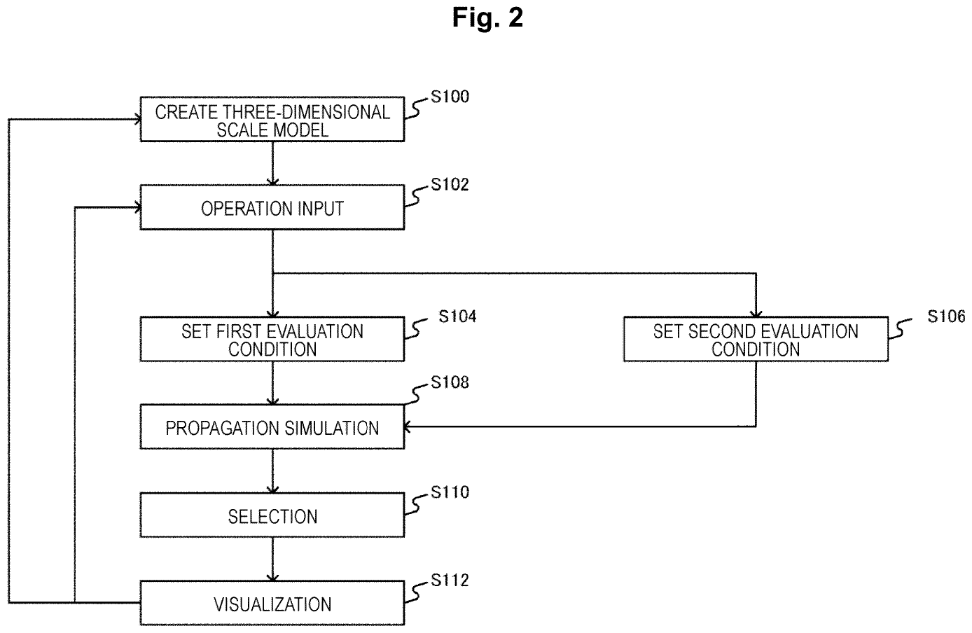

Next, an example of a radio wave visualization method of visualizing radio waves by the radio wave visualization system 1 will be described. FIG. 2 shows an example of the radio wave visualization method of visualizing radio waves by the radio wave visualization system 1.

As shown in FIG. 2, in order to visualize radio waves, the radio wave visualization system 1 first creates a three-dimensional scale model (S100). Then, the radio wave visualization system 1 receives an operation input to the UI unit 30 by the operator (S102).

Next, the radio wave visualization system 1 sets an evaluation condition (first evaluation condition) to the first propagation simulator 61 (S104) and sets an evaluation condition (second evaluation condition) to the second propagation simulator 62 (S106).

Then, in the radio wave visualization system 1, the propagation simulator 6 executes propagation simulations based on the first evaluation condition and the second evaluation condition in parallel, for example (S108).

The selection unit 7 selects a simulation result executed by the propagation simulator 6 by using the evaluation condition created by the second evaluation condition creation unit 32 in preference to a simulation result executed by the propagation simulator 6 by using the evaluation condition created by the first evaluation condition creation unit 31 (S110).

The visualization unit 8 sequentially visualizes the simulation results of a plurality of propagation characteristics selected by the selection unit 7.

Then, if an operation input is further made to the UI unit 30 by the operator, the radio wave visualization system 1 returns to the processing in S102. If it is necessary to create a three-dimensional scale model again due to a change in a target environment or the like, the radio wave visualization system 1 returns to the processing in S100.

As described above, the radio wave visualization system 1 selects the simulation result executed by the propagation simulator 6 by using the evaluation condition created by the second evaluation condition creation unit 32 in preference to the simulation result executed by the propagation simulator 6 by using the evaluation condition created by the first evaluation condition creation unit 31 and sequentially visualizes the simulation results. This makes it possible to reduce a time required for visualizing radio wave propagation according to an assumed frequency of use of radio waves.

Note that some or all of each unit included in the radio wave visualization system 1 may be configured by hardware such as a programmable logic device (PLD) or a field programmable gate array (FPGA) or may be configured as a program executed by a processor such as a CPU.

For example, each unit included in the radio wave visualization system 1 can be implemented by using a computer and a program, and the program can be recorded in a storage medium or provided through a network.

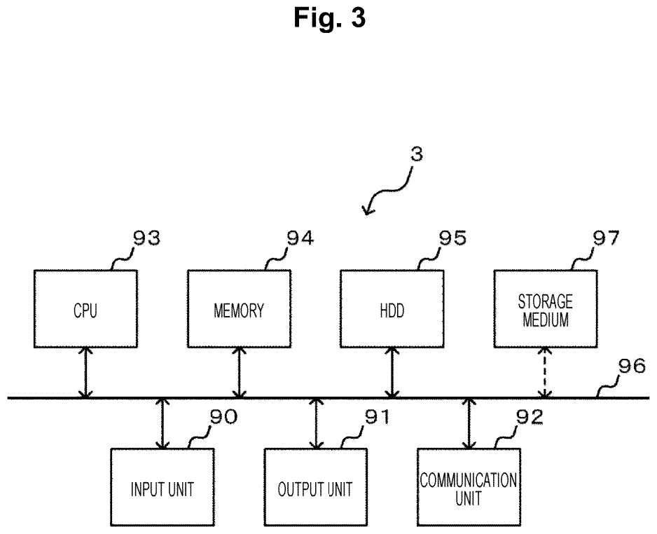

FIG. 3 shows a hardware configuration example of the evaluation condition creation device 3. As shown in FIG. 3, for example, the evaluation condition creation device 3 is such that an input unit 90, an output unit 91, a communication unit 92, a CPU 93, a memory 94, and an HDD95 are connected via a bus 96 and has functions of a computer. The evaluation condition creation device 3 can input and output data to and from a computer-readable storage medium 97.

The input unit 90 is included in, for example, the UI unit 30 described above and is, for example, a keyboard or a mouse. The output unit 91 is, for example, a display device such as a display corresponding to the visualization unit 8 described above. The communication unit 92 is, for example, a network interface.

The CPU93 controls each unit included in the evaluation condition creation device 3 and performs predetermined processing and the like. The memory 94 and the HDD 95 are storage units that store data and the like.

The storage medium 97 can store a program or the like for executing functions of the evaluation condition creation device 3. Note that the architecture constituting the evaluation condition creation device 3 is not limited to the example of FIG. 3.

### REFERENCE SIGNS LIST

1 Radio wave visualization system
2 Model creation unit
3 Evaluation condition creation device
4 Prediction unit
5 Change unit
6 Propagation simulator
7 Selection unit
8 Visualization unit
30 UI unit
31 First evaluation condition creation unit
32 Second evaluation condition creation unit
61 First propagation simulator
62 Second propagation simulator
90 Input unit
91 Output unit
92 Communication unit
93 CPU
94 Memory
95 HDD
96 Bus
97 Storage medium

1. A radio wave visualization system comprising:
model creation circuitry configured to create a three-dimensional scale model of an environment including a terrain and a building of an area to be evaluated for a propagation characteristic of radio waves used for a wireless communication system in which a base station and a terminal station perform wireless communication;
UI circuitry configured to output base station information indicating a position of the base station and terminal station information indicating a position and moving state of the terminal station in response to an operation input by an operator;
first evaluation condition creation circuitry configured to create a plurality of evaluation conditions used for evaluating the propagation characteristic of radio waves for the area on the basis of the base station information and the terminal station information output by the UI circuitry and performance of the wireless communication system;
second evaluation condition creation circuitry configured to create a plurality of evaluation conditions used for evaluating the propagation characteristic of radio waves for the area on the basis of the base station information and the terminal station information output by the UI circuitry, the performance of the wireless communication system, and the environment of the area according to an assumed frequency of use of radio waves in order from a highly frequent area where the frequency of use of radio waves is assumed to be high;
a propagation simulator that simulates a plurality of propagation characteristics by using the plurality of evaluation conditions created by the first evaluation condition creation circuitry and the second evaluation condition creation circuitry for the three-dimensional scale model created by the model creation circuitry and outputs simulation results;
selection circuitry configured to select the simulation results executed by the propagation simulator by using the evaluation conditions created by the second evaluation condition creation circuitry in preference to the simulation results executed by the propagation simulator by using the evaluation conditions created by the first evaluation condition creation circuitry; and
visualization circuitry configured to sequentially visualize the simulation results of the plurality of propagation characteristics selected by the selection circuitry.

2. The radio wave visualization system according to claim 1, further comprising
prediction circuitry configured to predict a possible movement destination of the terminal station on the basis of the terminal station information output by the UI circuitry, wherein
the second evaluation condition creation circuitry
create the plurality of evaluation conditions used for evaluating the propagation characteristic of radio waves for the area on the basis of the possible movement destination of the terminal station predicted by the prediction circuitry.

3. The radio wave visualization system according to claim 1, wherein
the propagation simulator
performs the simulation of the plurality of propagation characteristics using the evaluation conditions created by the first evaluation condition creation circuitry and the simulation of the plurality of propagation characteristics using the evaluation conditions created by the second evaluation condition creation circuitry in parallel.

4. The radio wave visualization system according to claim 1, wherein
the propagation simulator
simulates the propagation characteristics in descending order of distance between the base station and the terminal station.

5. The radio wave visualization system according to claim 1, further comprising
change circuitry configured to change a condition for setting a highly frequent area where a frequency of use of radio waves is assumed to be high for the second evaluation condition creation circuitry.

6. An evaluation condition creation device that, for a propagation simulator that simulates a propagation characteristic of radio waves used for a wireless communication system in which a base station and a terminal station perform wireless communication by using a three-dimensional scale model of an environment including a terrain and a building of an area to be evaluated, creates a plurality of evaluation conditions used for evaluating the propagation characteristic of radio waves, the evaluation condition creation device comprising:
UI circuitry configured to output base station information indicating a position of the base station and terminal station information indicating a position and moving state of the terminal station in response to an operation input by an operator;
first evaluation condition creation circuitry configured to create a plurality of evaluation conditions used for evaluating the propagation characteristic of radio waves for the area on the basis of the base station information and the terminal station information output by the UI circuitry and performance of the wireless communication system; and
second evaluation condition creation circuitry configured to create a plurality of evaluation conditions used for evaluating the propagation characteristic of radio waves for the area on the basis of the base station information and the terminal station information output by the UI circuitry, the performance of the wireless communication system, and the environment of the area according to an assumed frequency of use of radio waves in order from a highly frequent area where the frequency of use of radio waves is assumed to be high.

7. A radio wave visualization method comprising:
creating a three-dimensional scale model of an environment including a terrain and a building of an area to be evaluated for a propagation characteristic of radio waves used for a wireless communication system in which a base station and a terminal station perform wireless communication;
outputting base station information indicating a position of the base station and terminal station information indicating a position and moving state of the terminal station in response to an operation input by an operator;
creating a plurality of evaluation conditions used for evaluating the propagation characteristic of radio waves for the area on the basis of the base station information and the terminal station information output in outputting and performance of the wireless communication system;
creating a plurality of evaluation conditions used for evaluating the propagation characteristic of radio waves for the area on the basis of the base station information and the terminal station information output in outputting, the performance of the wireless communication system, and the environment of the area according to an assumed frequency of use of radio waves in order from a highly frequent area where the frequency of use of radio waves is assumed to be high;
simulating a plurality of propagation characteristics by using the plurality of evaluation conditions created in first evaluation condition creation and second evaluation condition creation for the three-dimensional scale model created in model creation and outputting simulation results;
selecting the simulation results executed in propagation simulation by using the evaluation conditions created in second evaluation condition creation in preference to the simulation results executed by using the evaluation conditions created in first evaluation condition creation; and
sequentially visualizing the simulation results of the plurality of propagation characteristics selected in selection.

8. A non-transitory computer-readable storage medium storing an evaluation condition creation program for causing a computer to function as each circuitry of the evaluation condition creation device according to claim 6.
